(19) United States
(12) Patent Application Publication
(10) Pub. No.: US 2017/0185243 A1
(43) Pub. Date: Jun. 29, 2017

(54) USER INTERFACE ACTION CONTROL

(71) Applicant: SuccessFactors, Inc., South San Francisco, CA (US)

(72) Inventors: Vijayalakshmi Palanikumar, Bangalore (IN); Satish Ramteare, Bangalore (IN)

(21) Appl. No.: 14/982,525

(22) Filed: Dec. 29, 2015

(51) Int. Cl. G06F 3/0482; G06F 3/0484

(52) U.S. Cl. CPC G06F 3/0482; G06F 3/04847

(57) ABSTRACT

Methods, systems, and computer program products for triggering actions are described. An indication of a live change event in a specified paste area is received, the paste area being a defined area of a user interface, a location of the paste area being visually indicated by another user interface element. A list of items pasted into the specified paste area is obtained. A defined action is performed utilizing at least one of the items.

### FIELD

The present disclosure relates generally to a user interface. In an example embodiment, the disclosure relates to a mechanism for triggering actions via a user interface.

### BACKGROUND

User interfaces, such as graphical user interfaces (GUI's), provide users with a user-friendly mechanism to submit data, initiate actions, and view output in interacting with an application or other software entity. GUI's may enhance efficiency and ease of use for users interacting with a computer. Data may be entered using keyboards and pointing devices into, for example, free text fields, structured data fields, drop-down windows, and the like. Computer actions may be initiated by entering text-based commands via a keyboard or selecting icons, hypertext links, and the like via a pointing device, such as a mouse or trackpad. Often, a large amount of information, such as a list of shopping items or a list of recipients of an electronic mail message, may need to be entered by a user,

Consuming valuable time and introducing an opportunity for typographical and other types of errors.

### SUMMARY

In some implementations, methods and apparatus, including computer program products, are provided for triggering actions via a user interface. In one aspect, an indication of a live change event in a paste area is received, the paste area being a defined area of a user interface, and a list of items pasted onto the paste area are obtained. The list of items is segmented into a plurality of segmented items and a defined hardware-based action utilizing at least one of the segmented items is performed.

The above methods, apparatus, and computer program products may, in some implementations, further include one or more of the following features.

In one example embodiment, the performance of the hardware-based action is repeated until all of the items in the list are processed. Moreover, the list of items may be pasted onto the paste area prior to obtaining the pasted list of items and the segmenting of the list of items may further comprise converting the list of items into an array of items.

In one example embodiment, one or more items are selected to create the list of items and the defined action may comprise entering the at least one segmented item into a field of a user interface. The defined action may be the action of forwarding the at least one segmented item to a software application. The defined action may be identified by the at least one segmented item. In one example embodiment, one or more boundaries of the paste area are defined. The paste area may be invisible and a location of the paste area may be visually indicated by another user interface element.

### BRIEF DESCRIPTION OF DRAWINGS

The present disclosure is illustrated by way of example and not limitation in the figures of the accompanying drawings, in which like references indicate similar elements and in which:

FIG. 1 is a block diagram of an example computer processing system, in accordance with an example embodiment, for generating a user interface and interfacing with a software application or other entity;

FIG. 2 is a block diagram of an example apparatus, in accordance with an example embodiment, for interfacing with a software entity, such as a software application;

FIG. 3 is a representation of an example user interface for purchasing items on an electronic commerce marketplace, in accordance with an example embodiment;

FIG. 4 is a representation of an example user interface for generating electronic mail, in accordance with an example embodiment;

FIG. 5 is a workflow diagram for an example system for entering a list of items into a user interface and triggering actions based on the items, in accordance with an example embodiment;

FIG. 6 is a flowchart for an example method for initiating an action based on a copied list of items, in accordance with an example embodiment;

FIG. 7 is a representation of the submission of a list of shopping items into the example user interface of FIG. 3, in accordance with an example embodiment;

FIG. 8 is a representation of the submission of a list of electronic mail recipients into the example user interface of FIG. 4, in accordance with an example embodiment;

FIG. 9 is a block diagram illustrating a mobile device, according to an example embodiment; and

FIG. 10 is a block diagram of a computer processing system within which a set of instructions, for causing the computer processing system to perform any one or more of the methodologies discussed herein, may be executed.

### DETAILED DESCRIPTION

The description that follows includes illustrative systems, methods, techniques, instruction sequences, and computing program products that embody example embodiments of the present invention. In the following description, for purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures and techniques have not been shown in detail.

Generally, methods, systems, and apparatus for entering a list of items in a user interface and triggering actions based on the items are described. In one example embodiment, a user may copy a list of items, such as a text-based list of items, and paste the list onto a user interface element, such as an icon, to trigger an action(s) based on the list of items. As used herein, an “item” may refer to an identification of a physical object (such as a grocery item), a name or identification of a person (such as a recipient of electronic mail), an action identifier (such as starting an application, sending electronic mail, and the like), and the like. The pasting of the list onto a defined paste area triggers the action(s).

The paste area may be hidden; i.e., the paste area is not necessarily visually identified as a paste area to a user but, rather, is visually identified by another user interface element, such as an icon, a user interface field, and the like. The paste area may be made hidden by, for example, setting a cascading style sheets (CSS) opacity property of the paste area to zero. The boundary(ies) of the paste area may be different or the same as the boundary(ies) of the user interface element. In one example embodiment, the paste area is a text area. A user can paste the copied list of items onto the paste area by selecting the paste area (such as by positioning a cursor over the paste area) and clicking on the paste area provided on the page, either by using a paste key shortcut from the keyboard (e.g., control-“v” in the user interface window), by using mouse commands (e.g., right click) and picking the paste option from the context menu, and the like. In one example embodiment, a drag-and-drop technique may be used to drop the list of items onto the paste area. The paste area is monitored for a live change event and, when detected, the live change event (e.g., the pasting of the list of items onto the paste area) is processed to trigger the corresponding action(s). A live change event, as used herein, is a change event applied to the paste area.

In one example embodiment, a user interface handler is configured to perform particular actions based on the content pasted onto the paste area. The pasted content, in the form, for example, of a list of items, is converted into a segmented set of items. For example, the item list can be converted to an array of items by, for example, using a JavaScript method. A JavaScript Array.split method, for example, may be used to segment, or split, the pasted content into the array. The segmentation may be based, for example, on a newline character between items in the list. The array (or other structure of segmented items) is then used to trigger various actions via, for example, a user interface page. In one example embodiment, the actions are based on the items in the list. In one example embodiment, the actions are explicitly defined by the list of items.

The paste area can be a mask on the page, a part of the page, or a control in the page. The effect may be to give the user the perception that the pasting operation is directly triggering the action. For example, a copied list of grocery items may be pasted onto a shopping cart icon of a shopping application. Since the shopping cart icon area is masked by the paste area, the pasting operation will have the effect of loading the identity of the grocery items into the shopping cart. Similarly, pasting a copied list of recipients into a recipient field of an electronic mail composition window will have the effect of loading the electronic mail addresses of the recipients into the recipient field.

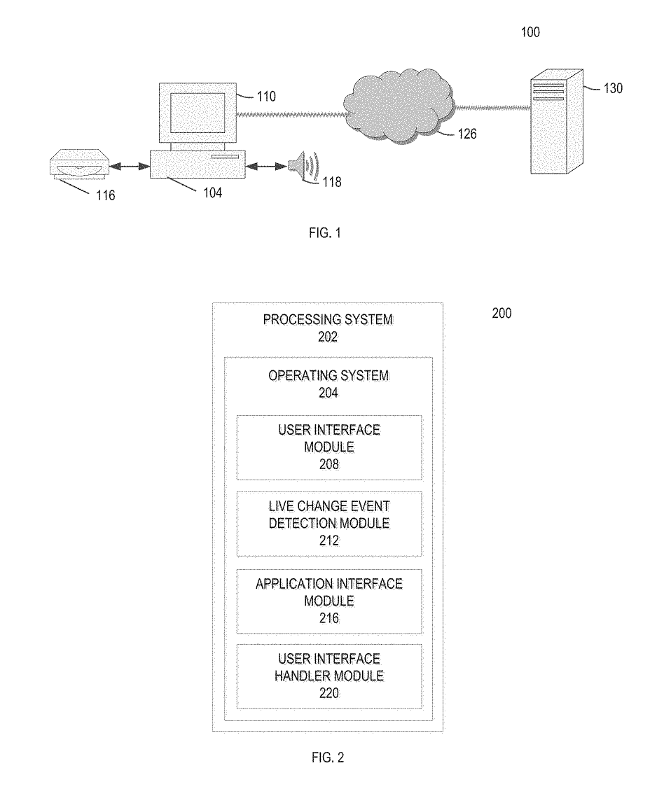

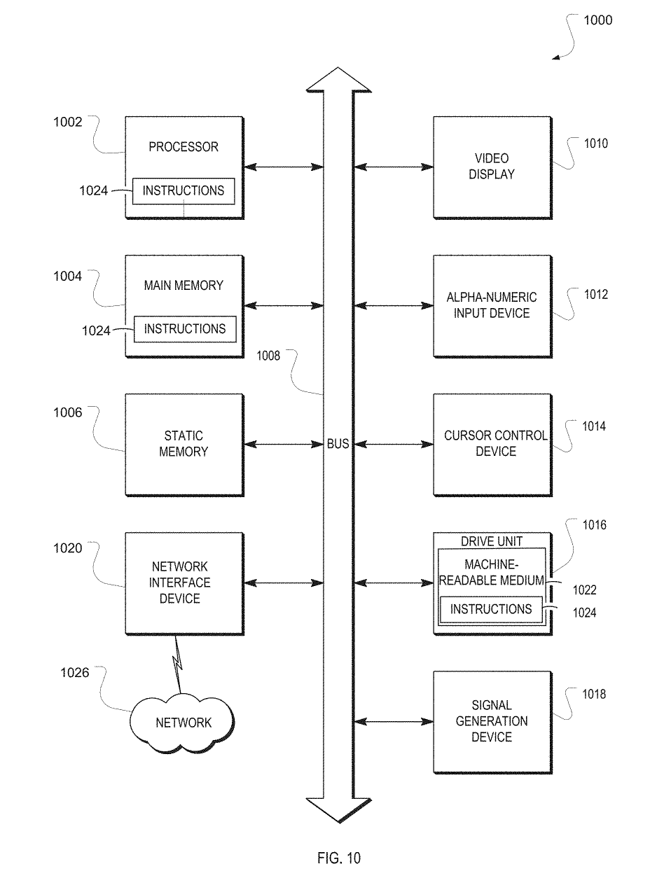

FIG. 1 is a block diagram of an example computer processing system 100, in accordance with an example embodiment, for generating a user interface and interfacing with a software application or other entity. As described more fully below in conjunction with FIG. 10, in some embodiments, the computer processing system 100 operates as a standalone device 104 or may be connected (e.g., networked) to other computers 130. In a networked deployment, the computer processing system 100 may operate in the capacity of a server or a client computer in a server-client network environment, or as a peer computer in a peer-to-peer (or distributed) network environment.

The example computer processing system 100 includes a processor (e.g., a central processing unit (CPU), a graphics processing unit (GPU), or both), and a main memory which communicate with each other via a bus. The computer processing system 100 may further include a video display 110 (e.g., a plasma display, a liquid crystal display (LCD), or a cathode ray tube (CRT)). The computer processing system 100 also includes an alphanumeric input device (e.g., a keyboard), a user interface (UI) navigation device (e.g., a mouse and/or touch screen), a drive unit 116, a signal generation device 118 (e.g., a speaker), and a network interface device.

The drive unit 116 includes a machine-readable medium on which is stored one or more sets of instructions and data structures embodying or utilized by any one or more of the methodologies or functions described herein. The instructions may also reside, completely or at least partially, within the main memory, a static memory, and/or the processor during execution thereof by the computer processing system 100, the main memory, the static memory, and the processor also constituting tangible machine-readable media. The instructions may further be transmitted or received over a network 126 via the network interface device utilizing any one of a number of well-known transfer protocols (e.g., Hypertext Transfer Protocol).

The network 126 may be may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, a network of interconnected networks, or a combination of two or more such networks, and the like.

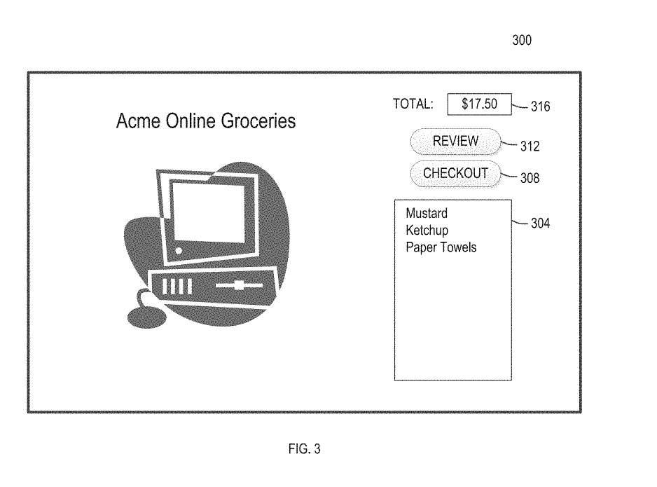

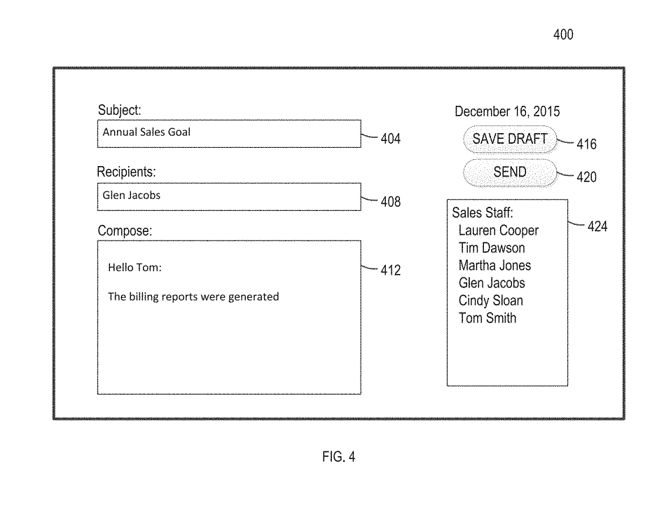

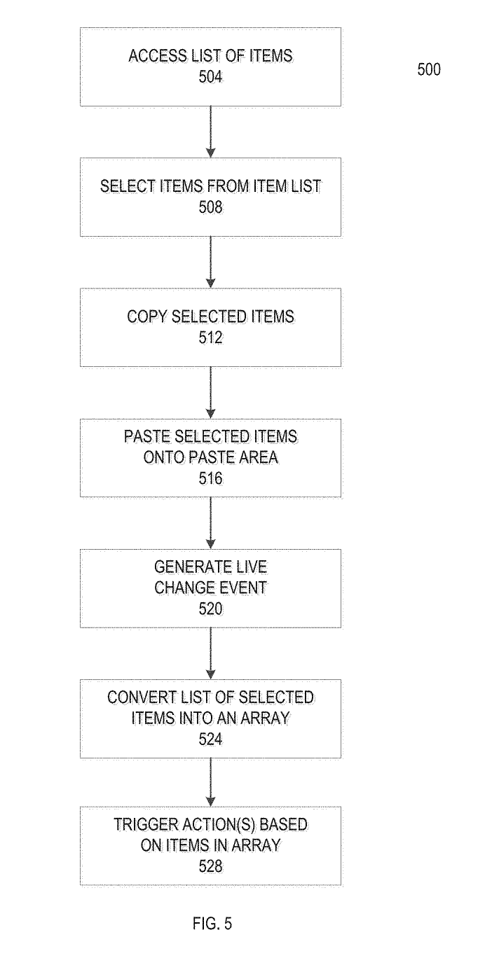

The computer processing system 100 generates a user interface, such as the user interfaces of FIGS. 3 and 4. Each user interface allows a user to interface with an application or other software entity, such as an electronic mail application or an electronic commerce application. Data may be entered or selected using the alphanumeric input device and the UI navigation device into, for example, free text fields, structured data fields, drop-down windows, graphical icons, and the like. Computer actions may be initiated by entering text-based commands via the alphanumeric input device or selecting icons, hypertext links, and the like via the UI navigation device (e.g., a pointing device, such as a mouse or trackpad).

FIG. 2 is a block diagram of an example apparatus 200, in accordance with an example embodiment, for interfacing with a software entity, such as a software application. The apparatus 200 is shown to include a processing system 202 that may be implemented on a client or other processing device that includes an operating system 204 for executing software instructions. In accordance with an example embodiment, the apparatus 200 may include a user interface module 208, a live change event detection module 212, an application interface module 216, and a user interface handler module 220.

The user interface module 208 provides access to item lists (such as text-based lists), provides for the copying of the item lists, and provides the ability to paste the item lists in a paste area, such as a hidden text area, of a user interface entity, such as a page, window, and the like. The user interface module 208 interfaces with other software entities, such as the application interface module 216 and the user interface handler module 220, in order to submit the list of items as a trigger for a particular action(s). The user interface module 208 may generate user interfaces, such as the user interfaces of FIGS. 3 and 4.

The live change event detection module 212 detects events, such as the pasting of an item list onto a paste area. The live change event detection module 212 informs the user interface handler module 220 of a detected live change event.

The application interface module 216 provides an interface to a software entity, such as an application. The application interface module 216 may receive a request from the user interface handler module 220 to perform certain actions based on a list of items and forward the request to an application, such as an electronic commerce application or an electronic mail application.

The user interface handler module 220 may receive an item list, or a data structure (e.g., an array) derived from the item list, from the user interface module 208 and may facilitate one or more actions based on the item list. For example, the user interface handler module 220 may enter the items in the field(s) of a user interface on behalf of a user, or may bypass the user interface and forward the items directly to a software entity, such as an application.

FIG. 3 is a representation of an example user interface 300 for purchasing items on an electronic commerce marketplace, in accordance with an example embodiment. In one example embodiment, the user interface 300 may be generated by the user interface module 208 and may be utilized by a user of the computer processing system 100 to purchase a list of items on an electronic commerce marketplace.

In one example embodiment, grocery items may be entered into a shopping cart 304, and a review button 312 may be selected to review the selected items. A purchase (CHECKOUT) button 308 may be selected to purchase the items in the shopping cart 304. In the example user interface 300, the items in the shopping cart 304 include mustard, ketchup, and paper towels. The total purchase price is displayed in a cost field 316.

FIG. 4 is a representation of an example user interface 400 for generating electronic mail, in accordance with an example embodiment. In one example embodiment, the user interface 400 may be generated by the user interface module 208 and may be utilized by a user of the computer processing system 100 to compose and issue electronic mail.

The user interface 400 may be a window, e.g., a pop-up window, and may display a representation of an electronic mail message. The user may select a subject field 404, a recipient field 408, or a text composition field 412 using a pointing device, such as a trackpad, mouse, and the like, to generate the electronic mail. One or more recipients of the message may be entered in the recipient field 408, a subject of the message may be entered in the subject field 404, and a text message may be composed in the text composition field 412. A draft of the message may be saved by selecting a SAVE DRAFT button 416, or the message may be sent to the recipients by selecting a SEND button 420. A list of members of the sales staff is provided in pane 424.

FIG. 5 is a workflow diagram 500 for an example system for entering a list of items into a user interface and triggering actions based on the items, in accordance with an example embodiment. In one example embodiment, a user accesses an item list, such as a text-based item list, via, for example, an application, such as Microsoft Word of the Microsoft Corporation of Redmond, Wash., USA (operation 504). One or more items in the list are selected using, for example, a pointing device (operation 508), and a copy command is issued by, for example, entering control-“c” on a keyboard of the computer processing system 100 (operation 512).

The copied list of selected items is then pasted by, for example, using a pointing device to select the paste area and by, for example, entering control-“v” on the keyboard (operation 516). While the boundary of the paste area may not be visible to the user, the general location of the paste area may be indicated by, for example, an icon, such as a shopping cart icon. The pasting of the list of selected items will generate a live change event (operation 520) that may be detected by, for example, the live change event detection module 212. In response to the detection of the live change event, the pasted list of selected items is optionally converted into a plurality of segmented items by, for example, converting the list of selected items into an array (operation 524). The segmented list (e.g., an array of items) is then used to trigger various actions on the page (operation 528). In one example, the actions are based on the items in the array. For example, if the list of selected items is a list of grocery items to be deposited into an electronic shopping cart, the action can be the submission of the items to an electronic commerce web site via an interface for the electronic commerce web site. The grocery items may be submitted one at a time, or submitted as a group of items, depending on the capabilities of the interface and the electronic commerce web site. In one example embodiment, the interface may be a user interface, where the user interface module 208 enters the items in fields of the electronic commerce web site's user interface on behalf of a user. In one example embodiment, the interface may be a computer interface that allows the application interface module 216 to forward the items directly to the electronic commerce web site.

In one example, each item explicitly specifies one or more actions to perform. For example, the items may be the following actions: 1) enter subject line “Annual Sales Goal”; 2) enter recipient “Tom Smith”; and 3) enter text field “Are the billing reports ready?”

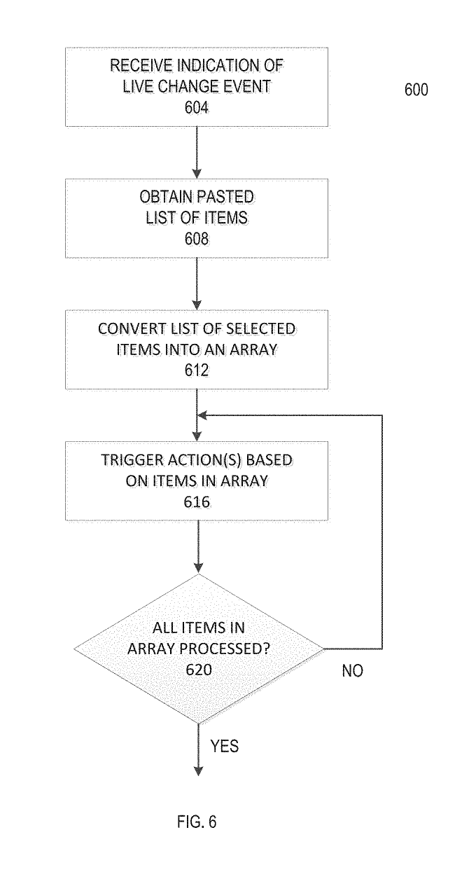

FIG. 6 is a flowchart for an example method 600 for initiating an action based on a copied list of items, in accordance with an example embodiment. In one example embodiment, one or more of the operations of the method 600 may be performed by the user interface handler module 220.

An indication of a live change event in a specified paste area is received from, for example, the live change event detection module 212 (operation 604). The list of items that were pasted onto the paste area and that caused the live change event is obtained from, for example, the user interface module 208 (operation 608). The list of items is optionally segmented into individual items by, for example, executing a JavaScript Array.split method to segment, or split, the pasted content (operation 612).

One or more items are obtained from the segmented content and a defined action is performed utilizing the one or more items (operation 616). For example, if the items are names of recipients of an electronic mail message, the names may be entered in the recipient field 408 of the user interface 400. In one example embodiment, JavaScript may be used to render or set values on the corresponding user interface controls based on the items in the segmented content. For the above example, the segmented list of names is processed to obtain the email addresses corresponding to the names and the list of email addresses are set as values of the recipient field.

A test is performed to determine if all items in the array have been processed (operation 620). If all items in the array have been processed, the method 600 ends; otherwise, the method 600 proceeds with operation 616 and one or more unprocessed items from the segmented content are obtained and the corresponding action(s) are triggered.

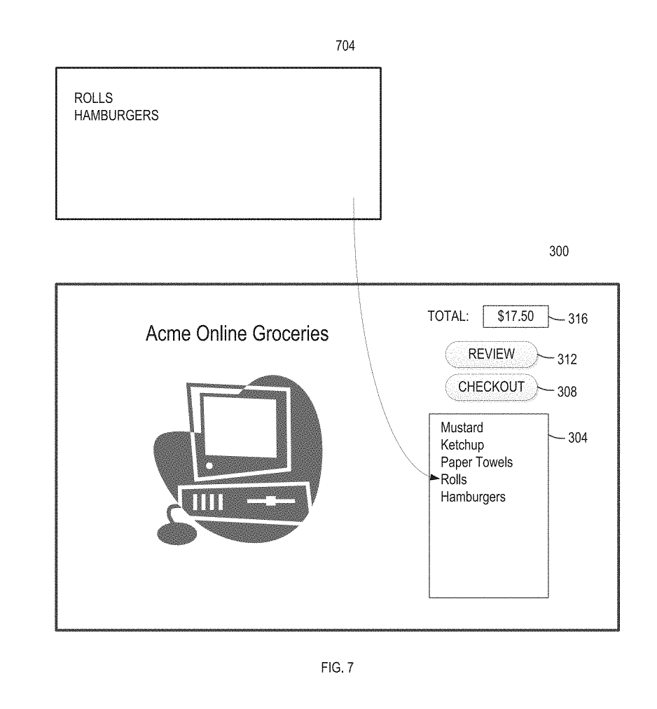

FIG. 7 is a representation of the submission of a list of shopping items into the example user interface 300, in accordance with an example embodiment. In one example embodiment, a text-based list of items 704 is accessed, copied, and pasted onto the paste area of the shopping cart 304. The pasting can be performed by, for example, selecting one or more items from the text-based list of items 704 using a mouse or track pointer, entering control-“c” on a keyboard, and entering control-“v” on the keyboard while selecting the paste area of the shopping cart 304 using a mouse or track pointer. Alternatively, the text-based list of items 704, or a selection of items in the text-based list of items 704, can be dragged and dropped onto the paste area of the shopping cart 304 using a mouse or track pointer. Once the pasting operation is executed, the action(s) corresponding to the pasted item(s) are initiated by, for example, the user interface handler module 220. For example, the pasted items are deposited into the shopping cart 304.

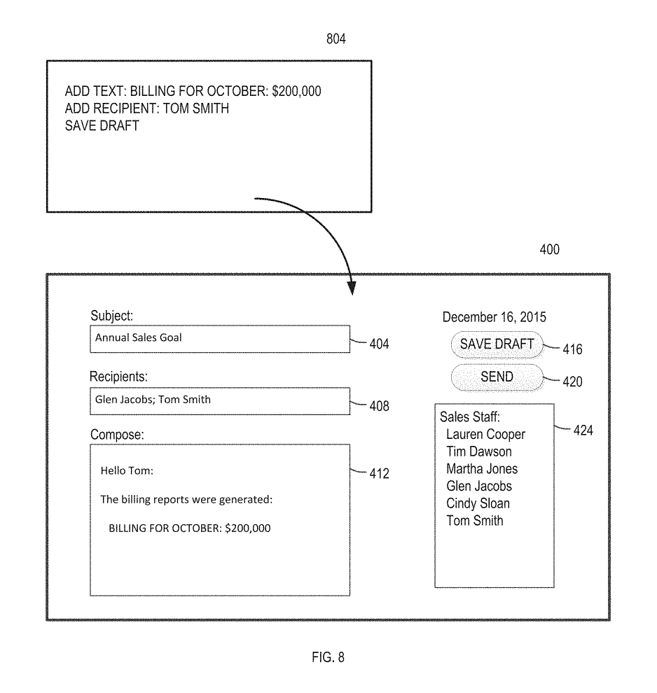

FIG. 8 is a representation of the submission of a list of electronic mail recipients into the example user interface 400, in accordance with an example embodiment. In one example embodiment, a text-based list of items 804 is accessed, copied, and pasted onto the paste area of the user interface 400. The pasting can be performed by, for example, selecting one or more items (actions) from the text-based list of items 804 using a mouse or track pointer, entering control-“c” on a keyboard, and entering control-“v” on the keyboard while selecting the paste area of the user interface 400 using a mouse or track pointer. Alternatively, the text-based list of items 804, or a selection of items in the text-based list of items 804, can be dragged and dropped onto the paste area of the user interface 400 using a mouse or track pointer. Once the pasting operation is executed, the action(s) corresponding to the pasted item(s) are initiated by, for example, the user interface handler module 220.

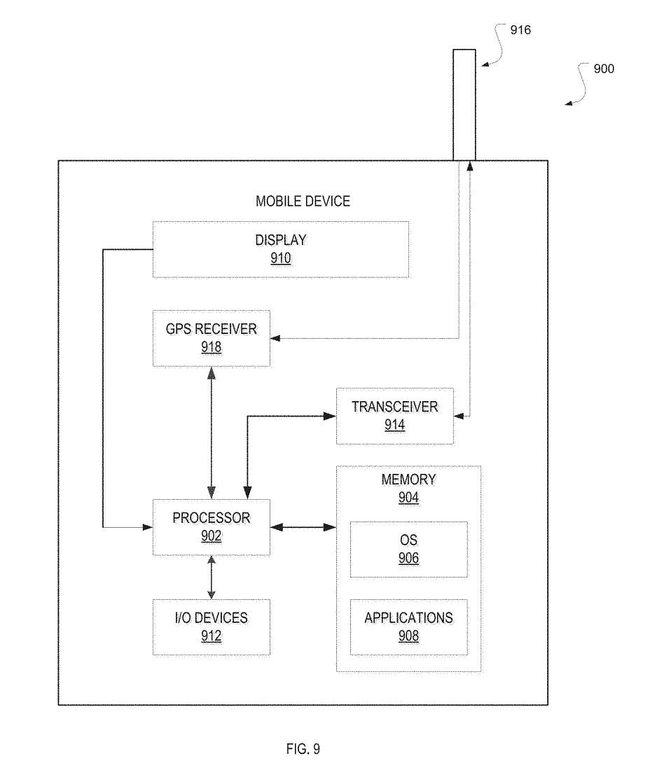

FIG. 9 is a block diagram illustrating a mobile device 900, according to an example embodiment. The mobile device 900 can include a processor 902. The processor 902 can be any of a variety of different types of commercially available processors suitable for mobile devices 900 (for example, an XScale architecture microprocessor, a Microprocessor without Interlocked Pipeline Stages (MIPS) architecture processor, or another type of processor). A memory 904, such as a random access memory (RAM), a flash memory, or another type of memory, is typically accessible to the processor 902. The memory 904 can be adapted to store an operating system (OS) 906, as well as applications 908, such as a mobile location enabled application that can provide location-based services (LBS's) to a user. The processor 902 can be coupled, either directly or via appropriate intermediary hardware, to a display 910 and to one or more input/output (I/O) devices 912, such as a keypad, a touch panel sensor, and a microphone. Similarly, in some embodiments, the processor 902 can be coupled to a transceiver 914 that interfaces with an antenna 916. The transceiver 914 can be configured to both transmit and receive cellular network signals, wireless data signals, or other types of signals via the antenna 916, depending on the nature of the mobile device 900. Further, in some configurations, a GPS receiver 918 can also make use of the antenna 916 to receive GPS signals.

FIG. 10 is a block diagram of a computer processing system 1000 within which a set of instructions 1024 may be executed for causing a computer to perform any one or more of the methodologies discussed herein. In some embodiments, the computer operates as a standalone device or may be connected (e.g., networked) to other computers. In a networked deployment, the computer may operate in the capacity of a server or a client computer in a server-client network environment, or as a peer computer in a peer-to-peer (or distributed) network environment.

In addition to being sold or licensed via traditional channels, embodiments may also, for example, be deployed by software-as-a-service (SaaS) providers, application service providers (ASP's), or utility computing providers. The computer may be a server computer, a personal computer (PC), a tablet PC, a set-top box (STB), a personal digital assistant (PDA), a cellular telephone, or any processing device capable of executing a set of instructions (sequential or otherwise) that specify actions to be taken by that device. Further, while only a single computer is illustrated, the term “computer” shall also be taken to include any collection of computers that, individually or jointly, execute a set (or multiple sets) of instructions to perform any one or more of the methodologies discussed herein.

The example computer processing system 1000 includes a processor 1002 (e.g., a CPU, a GPU, or both), a main memory 1004, and a static memory 1006, which communicate with each other via a bus 1008. The computer processing system 1000 may further include a video display 1010 (e.g., a plasma display, an LCD, or a CRT). The computer processing system 1000 also includes an alphanumeric input device 1012 (e.g., a keyboard), a UI navigation or cursor control device 1014 (e.g., a mouse and/or touch screen), a drive unit 1016, a signal generation device 1018 (e.g., a speaker), and a network interface device 1020.

The drive unit 1016 includes a machine-readable medium 1022 on which is stored one or more sets of instructions 1024 and data structures embodying or utilized by any one or more of the methodologies or functions described herein. The instructions 1024 may also reside, completely or at least partially, within the main memory 1004, the static memory 1006, and/or the processor 1002 during execution thereof by the computer processing system 1000, the main memory 1004, the static memory 1006, and the processor 1002 also constituting tangible machine-readable media 1022.

The instructions 1024 may further be transmitted or received over a network 1026 via the network interface device 1020 utilizing any one of a number of well-known transfer protocols (e.g., Hypertext Transfer Protocol).

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions 1024. The term “machine-readable medium” shall also be taken to include any medium that is capable of storing, encoding, or carrying a set of instructions 1024 for execution by the computer and that cause the computer to perform any one or more of the methodologies of the present application, or that is capable of storing, encoding, or carrying data structures utilized by or associated with such a set of instructions 1024. The term “machine-readable medium” shall accordingly be taken to include, but not be limited to, solid-state memories and optical and magnetic media.

While the embodiments of the invention(s) is (are) described with reference to various implementations and exploitations, it will be understood that these embodiments are illustrative and that the scope of the invention(s) is not limited to them. In general, techniques for maintaining consistency between data structures may be implemented with facilities consistent with any hardware system or hardware systems defined herein. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the invention(s).

What is claimed is:

1. A computerized method for triggering actions, the method comprising:
receiving an indication of a live change event in a paste area, the paste area being a defined area of a user interface, a location of the paste area being visually indicated by another user interface element;
obtaining a list of items pasted onto the paste area;
segmenting the list of items into a plurality of segmented items; and
performing a defined hardware-based action utilizing at least one of the segmented items.

2. The computerized method of claim 1, further comprising pasting the list of items onto the paste area prior to obtaining the pasted list of items.

3. The computerized method of claim 1, wherein the performing operation is repeated until all of the items in the list are processed.

4. The computerized method of claim 1, wherein the segmenting of the list of items further comprises converting the list of items into an array of items.

5. The computerized method of claim 1, further comprising selecting one or more items to create the list of items.

6. The computerized method of claim 1, wherein the defined action comprises entering the at least one segmented item into a field of a user interface.

7. The computerized method of claim 1, wherein the defined action is forwarding the at least one segmented item to a software application.

8. The computerized method of claim 1, wherein the defined action is identified by the at least one segmented item.

9. The computerized method of claim 1, further comprising defining one or more boundaries of the paste area.

10. The computerized method of claim 1, wherein the paste area is invisible.

11. An apparatus for triggering actions, the apparatus comprising:
one or more processors;
memory to store instructions that, when executed by the one or more hardware processors perform operations comprising:
receiving an indication of a live change event in a paste area, the paste area being a defined area of a user interface, a location of the paste area being visually indicated by another user interface element;
obtaining a list of items pasted onto the paste area;
segmenting the list of items into a plurality of segmented items; and
performing a defined hardware-based action utilizing at least one of the segmented items.

12. The apparatus of claim 11, wherein the performing operation is repeated until all of the items in the list are processed.

13. The apparatus of claim 11, wherein the segmenting of the list of items further comprises converting the list of items into an array of items.

14. The apparatus of claim 11, further comprising selecting one or more items to create the list of items.

15. The apparatus of claim 11, wherein the defined action comprises entering the at least one segmented item into a field of a user interface.

16. The apparatus of claim 11, wherein the defined action is forwarding the at least one segmented item to a software application.

17. The apparatus of claim 11, wherein the defined action is identified by the at least one segmented item.

18. The apparatus of claim 11, further comprising defining one or more boundaries of the paste area.

19. The apparatus of claim 11, wherein the paste area is invisible.

20. A computer-readable medium embodying instructions that, when executed by a processor, perform operations comprising:
receiving an indication of a live change event in a paste area, the paste area being a defined area of a user interface, a location of the paste area being visually indicated by another user interface element;
obtaining a list of items pasted onto the paste area;
segmenting the list of items into a plurality of segmented items; and
performing a defined hardware-based action utilizing at least one of the segmented items.
